(19) United States
(12) Patent Application Publication
(10) Pub. No.: US 2015/0213460 A1
(43) Pub. Date: Jul. 30, 2015

(54) CONTINUING-EDUCATION CERTIFICATE VALIDATION

(71) Applicants: Kent R. Anderson, Westborough, MA (US); David Barberich, Philadelphia, PA (US)

(72) Inventors: Kent R. Anderson, Westborough, MA (US); David Barberich, Philadelphia, PA (US)

(21) Appl. No.: 14/168,229

(22) Filed: Jan. 30, 2014

(51) Int. Cl. G06Q 30/00; G06Q 50/20

(52) U.S. Cl. CPC G06Q 30/0185; G06Q 50/20

(57) ABSTRACT

Various aspects of the present invention include validating continuing-education certificates received from participants in a continuing-education course. The certificates are analyzed to determine an identity of a provider of the continuing-education course and validated by comparing the identity of the provider to an authority file. A course credit associated with the continuing-education course may be determined, and a user database may be updated to reflect the course credit.

### TECHNICAL FIELD

Embodiments of the present invention relate generally to continuing education and, more particularly, to tracking continuing-education credits.

### BACKGROUND

Many professional organizations, employers, governing bodies, and other such groups require some or all of their members and/or employees to participate in educational programs deemed necessary, or at least useful, for career development, compliance with new laws or regulations, training in advances in technology or techniques, or similar reasons. These programs are variously known as continuing education (“CE”), continuing professional education (“CPE”), continuing professional development (“CPD”), or other such names; throughout this document, however, the phrase “continuing education” will be used to broadly connote these types of programs as a whole and without limitation to any particular type or category of program. Continuing-education requirements are typically ongoing, requiring a certain number of credits per year, for example. Typically, a participant attends or participates in a continuing-education program and, upon successful completion, is issued some form of certification document specifying an amount of credit earned. The participant may then submit the certification document to a managing organization or authority, which applies the earned credit to the participant's records.

Collecting these certificates, applying their credits to the appropriate participants, and tracking participants' progress against their credit goals may be a very labor-intensive process, however, that is prone to mistakes and misallocations. A given organization may include hundreds of thousands of members, or more, all of whose credits must be tracked. Credit-hour requirements may vary by country, state, or region, even within a given organization, further compounding the complexity of the credit-tracking process. Furthermore, a given participant may desire credit-hour certification in more than one region, but the regions may have different requirements, and credits from a given course may not apply in every region. Issuers of certificates may create and transmit them in a variety of different formats, such as on paper, via email, or as electronic documents, adding further complexity to the tracking process. A need therefore exits for a more efficient, less error-prone way to collect and track continuing-education certificates.

### SUMMARY

In general, various aspects of the systems and methods described herein include receiving a continuing-education course-completion certificate from a course participant, validating the authenticity of the certificate, extracting information from the certificate, and adding, to a user account associated with the participant, information about the course for which the certificate was granted. Certificates may be submitted in any of a variety of ways, including by email, fax, MMS messaging, or by a software client running on a device. The certificate may be validated by comparing information extracted from the certificate, such as the name of a course provider, to an authority file of known providers. The credit hours specified in the certificate may be applied to a user account associated with the participant, and the participant may log in to view his accumulated credits, progress toward credit requirements, and/or upcoming courses.

In one aspect, a method for electronically validating continuing-education certificates includes receiving, from a participant in a continuing-education course, electronic information comprising a certificate indicating completion of the continuing-education course; computationally analyzing the certificate to determine an identity of a provider of the continuing-education course; validating the certificate by electronically comparing the identity of the provider to an authority file; electronically determining a course credit associated with the continuing-education course; and updating a user database comprising a user account associated with the participant to reflect the course credit.

Analyzing the certificate may include extracting text from the received information; extracting text may include performing optical-character recognition on image data in the certificate. Analyzing the certificate may further include determining an address, logo, or letterhead of the provider and wherein validating the certificate further comprises comparing the address, logo, or letterhead to an authority file and/or determining a unique identifier associated with the certificate and wherein validating the certificate further comprises comparing the unique identifier to an authority file. The unique identifier may be a serial number, an alphanumeric string, a one-dimensional bar code, or a two-dimensional bar code. Validating the certificate may further include querying a third party with the unique identifier. The course credit may be applied to a course-credit requirement associated with a professional organization in which the participant is a member. The course-credit requirement may be determined based on requirements associated with the professional organization.

In another aspect, a system for validating continuing-education certificates includes an authority database for storing an authority file comprising validation information associated with a provider of a continuing-education course and a processor for executing computer instructions for receiving, from a participant in the continuing-education course, electronic information comprising a certificate indicating completion of the continuing-education course;

computationally analyzing the certificate to determine an identity of the provider of the continuing-education course; validating the certificate by comparing the identity of the provider to the authority file; determining a course credit associated with the continuing-education course; and updating a user database comprising a user account associated with the participant to reflect the course credit.

The electronic information may be received from a web browser, mobile device, or email account and may include an email, image file, fax, or MMS message. A course-requirements database for storing course-credit requirement information associated with a professional organization in which the participant is a member may be included. The course-credit requirement may be determined based on requirements associated with the professional organization. Analyzing the certificate may include extracting text from the received information. Extracting text may include performing optical-character recognition on image data in the certificate. Analyzing the certificate may further include determining an address, logo, or letterhead of the provider and wherein validating the certificate further comprises comparing the address, logo, or letterhead to an authority file.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a block diagram of a system for validating continuing-education certificates in accordance with embodiments of the present invention;

FIG. 2 is an exemplary system for validating continuing-education certificates in accordance with embodiments of the present invention;

FIG. 3 is a flowchart of a method for validating continuing-education certificates in accordance with embodiments of the present invention; and

FIG. 4 is an exemplary method for validating continuing-education certificates in accordance with embodiments of the present invention.

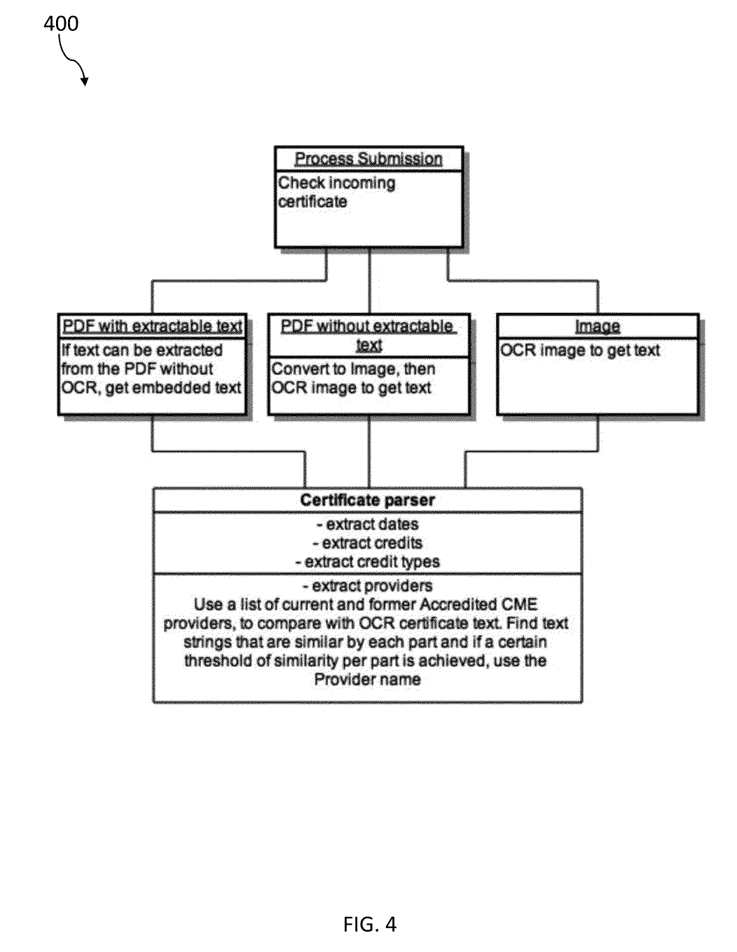

### DETAILED DESCRIPTION

Described herein are various embodiments of methods and systems for collecting, validating, and processing continuing-education credit certificates earned by participants in continuing-education programs. As described in greater detail below, a participant transmits his or her certificate electronically, and the certificate is received and analyzed to determine an identity of a provider. The certificate is validated by, for example, looking up the name of the provider in an authority database. The certificate is parsed to determine information about the associated course, such as the course name, type, and number of credits earned. This information may then be applied to a user account associated with the participant, which may further track the participant's number of accrued credits and compare these credits with one or more credit requirements, as defined by, for example, an associated professional organization. The participant may access his or her accumulated credits and view progress toward credit goals.

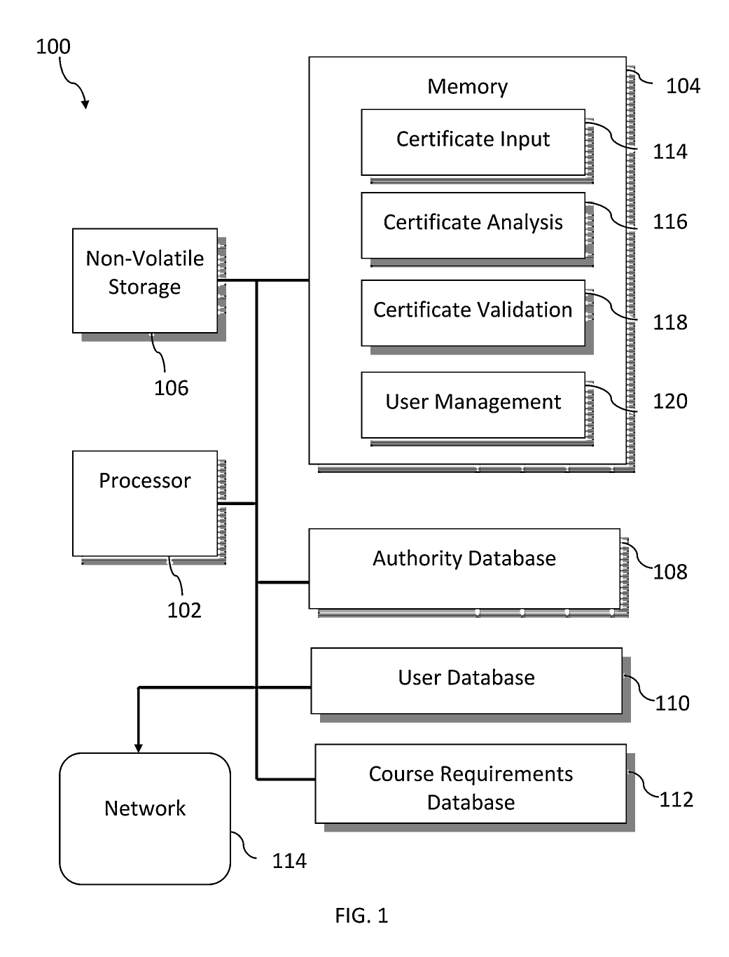

FIG. 1 illustrates a block diagram 100 of a computing system in accordance with embodiments of the present invention. The various components of the system 100 are presented only as an illustrative embodiment of the present invention; as one of skill in the art will understand, the system 100 may be implemented in any number of ways that are within the scope of the present invention. In this embodiment, the system 100 includes a processor 102, a memory 104, and non-volatile storage 106. The processor 102 may be, for example, one or more general-purpose microprocessors such as an INTEL CORE or an AMD K10; the memory 104 may be random-access memory such as SDRAM; and the non-volatile storage may be one or more magnetic or solid-state disk drives. As one of skill in the art will understand, the processor 102 executes computer instructions stored in the memory 104 and/or storage 106; the computer instructions may include operating-system, device-driver, network-interface and input-output instructions, as well as computer instructions implementing software applications or programs.

An authority database 108, a user database 110, and a course-requirements database 112 (as discussed further below) may be any type of relational or similar database built on any type of non-volatile storage (such as one or more disk drives). The databases 108, 110, 112 may be maintained separately or may be combined as one database; they may or may not be part of the non-volatile storage unit 106 discussed above. In other embodiments, the contents of the databases 108, 110, 112 may be maintained as system files (e.g., comma-separated value files) instead of database files. Any method of implementation of the databases 108, 110, 112 is within the scope of the current invention. The system 100 may further include a network interface 114 for connection to a network (such as the Internet, an intranet, a telephone voice or data network, or other such network), and other components or systems.

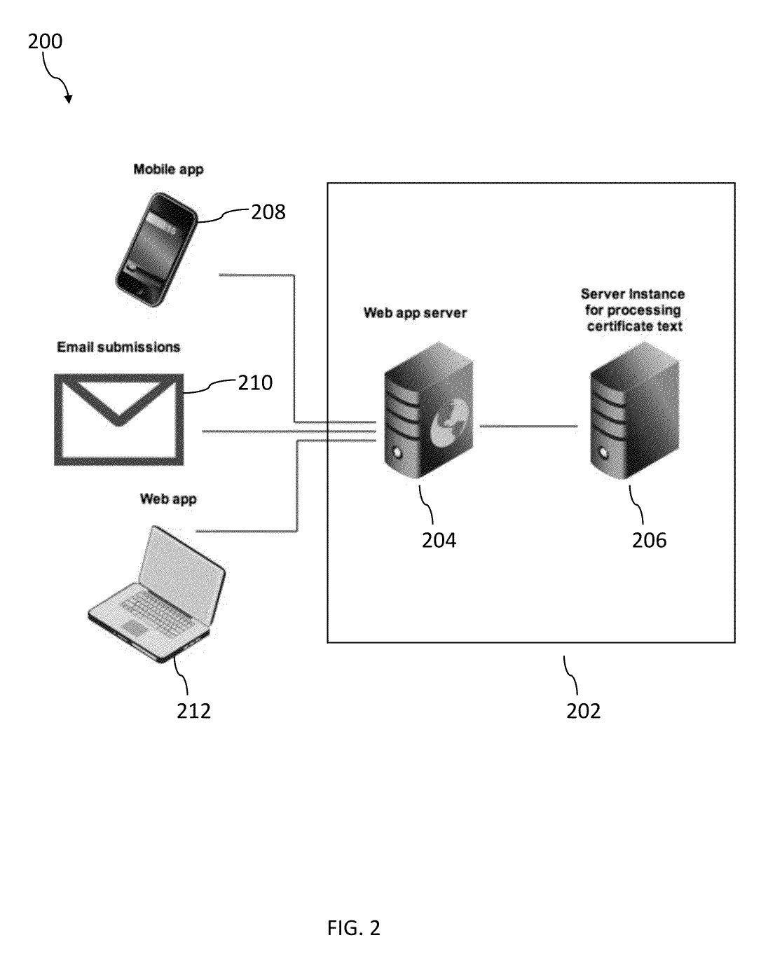

The system 100 receives electronic information that includes information regarding continuing-education certificates from participants in continuing-education programs. A continuing-education provider may issue one or more of a number of different types of certificates to a participant in a continuing-education program once that participant has completed the program. The certificate may be, for example, a printed sheet of paper, an electronic document in one of a variety of formats (e.g., ADOBE PDF, MICROSOFT WORD, or POSTSCRIPT), or an electronic image file (e.g., a JPEG, GIF, or PNG image). The certificate may further include binary computer data, such as an encrypted file or an encrypted certificate. FIG. 2 illustrates an environment 200 that includes another embodiment 202 of the system 100 described above; this embodiment 202 includes a web application server 204 and a server 206 for processing certificate text. The environment 200 further illustrates several exemplary systems and methods for submission of participant electronic information, such as a mobile device 208 running a mobile application, an email submission 210 (which may be a document or image file), and a personal computer 212 running a web-browser application.

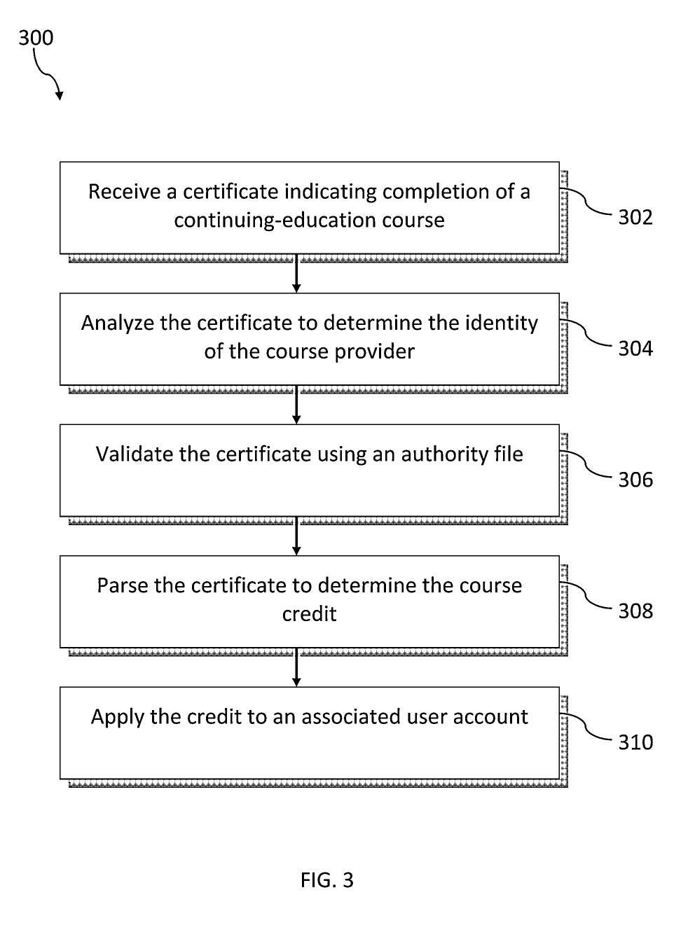

Embodiments of the present invention, such as the system 100 of FIG. 1, will now be further explained with reference to the flowchart 300 of FIG. 3, which illustrates an exemplary method of operation of the present invention. As the flowchart 300 illustrates, in a first step 302, electronic information indicating completion of a continuing education course, such as a certificate, is received. In a second step 304, the electronic information is analyzed to determine the identity of the course provider. In a third step 306, the certificate is validated using an authority file. In a fourth step 308, the certificate is parsed to determine information about the course (such as the credit offered), participant, or provider. In a fifth step 310, the credit is applied to a user account associated with the participant. These steps are described below in greater detail.

In the first step 302, a certificate is received via electronic means, such as via email or MMS messaging, by sharing a cloud-based file or document (using, for example, DROPBOX or GOOGLE DOCS), by transmission via a mobile or desktop software application, by fax, or by any other means. Referring also to the system 100 of FIG. 1, a certificate-input module 114 in the memory 104 includes computer instructions for receiving the certificate. The certificate-input module 114 may monitor the network interface 114 for incoming certificates by (for example) regularly polling the network interface or upon receiving a notification message or interrupt initiated by the network interface 114. The certificate-input module 114 may include an SMTP or similar mail server or inbox, for example, associated with one or more email addresses. A participant in a continuing-education course may send a certificate, attached to or in the body of an email, to the system 100 using an associated email address. The participant may alternatively or in addition send a link (such as a URL link) to a certificate in the body of an email; the certificate pointed to by the link may be hosted on any web server or file-sharing service.

The certificate-input module 114 may similarly monitor one or more telephone numbers associated with the system 100 for incoming fax transmissions or incoming MMS transmissions. A participant may therefore transmit a certificate via fax by dialing one of the associated telephone numbers from a fax machine, or by designating one of the associated telephone numbers in a computer software application or service that sends faxes.

The certificate-input module 114 may also include instructions for accessing one or more file-sharing utilities or services, such as GOOGLE DOCS or DROPBOX, via software APIs or similar means. The participant may send a pointer to the shared file via email, as discussed above, or may send a sharing request from within the file-sharing program or service (by, for example, clicking a “SHARE” button provided by the program or service). Prior to sending the email or share request, the participant may have uploaded or otherwise shared the certificate with the service of his or her choosing.

In other embodiments, the participant runs a software application on her mobile device or computer that communicates with the system 100. As discussed in greater detail below, the participant may use software application to collect and store her certificates, as received from continuing-education providers, and may direct the application to send the certificates and/or information contained therein to the certificate-input module 114. In various embodiments, the certificates may be synchronized manually or automatically. In one embodiment, a participant may request or give permission to a continuing-education provider to send a certificate directly to the certificate-input module 114 without the need for the participant to act as a middleman for transmission.

In still other embodiments, a participant may mail (using a postal service) a paper copy of a certificate to a real-world physical address associated with the system 100. In this embodiment, the paper certificate is manually or automatically scanned as digital data, which is then provided to the certificate-input module 114. Any system or method for receiving electronic information is within the scope of the present invention, however, and the certificate-input module 114 is not limited to the means of receipt described herein.

In the second step 304, the received electronic information (e.g., the certificate) is analyzed by a certificate-analysis module 116, which includes computer instructions for extracting information from the certificate. If the certificate contains electronically readable text, such as ASCII text, text in a MICROSOFT WORD or GOOGLE DOCS document, or text in a native PDF document, the certificate-analysis module 116 may read the text directly. If, however, the certificate includes text embedded in image data that is not directly readable as text (such as, for example, JPG or PNG images that include images of text or scanned PDF documents), the certificate-analysis module 116 may process the image data to identify text therein. For example, the certificate-analysis module 116 may perform one or more image-manipulation functions on the image data, such as contrast-correction, sharpening, or brightening functions. The certificate-analysis module 116 may further perform an optical-character recognition (“OCR”) function on the image data, algorithms for which are known in the art. In one embodiment, an OCR algorithm includes scanning the image data to detect shapes having a darker color than a background color and then comparing the detected shapes to shapes of known letters.

The text extracted from the certificate may be used in the third step 306, described in greater detail below, to validate the certificate. The certificate-analysis module 116 may thus extract any text in the certificate that may be useful for this validation. The text may include, for example, the name of a continuing-education provider; the address, telephone, email address, or other contact information of the provider; the name of the offered course; or other such information. Other text, such as text relating to the name of the participant or the number of credits earned, may be extracted in this step or in the fourth step 308, described in greater detail below.

The certificate-analysis module 116 may further analyze and extract non-textual data from the received certificate. For example, the certificate may include a logo or letterhead representing the certificate provider; in such cases, the certificate-analysis module 116 may identify this logo or letterhead and extract it to an image or data file (such as a JPG file) for later processing and analysis. The logo or letterhead may be identified by its position in the certificate (i.e., appearing at the top of the certificate), by its color, and/or by its shape (by, e.g., matching shapes in the certificate with a plurality of known shapes stored in the authority database 108). The certificate may include an image that encodes an identifying sequence of numbers, letters, or other characters, such as a one-dimensional bar code (e.g., a UPC code) or a two-dimensional bar code (e.g., a QR code). The certificate-analysis module 116 may identify and extract this coded image and decode it into its associated letters or numbers.

The received certificate may contain metadata information, such as EXIF image data, WORD DOCUMENT metadata such as author information, file modification date, file size, or any other such information. The certificate-analysis module 116 may collect this metadata, in addition to the above-referenced data, for later processing. The certificate-analysis module 116 may also analyze the received certificate for its document properties, such as font size, font type, font color, margin size, or any other such information.

In the third step 308, a certificate-validation module 118 validates the certificate using information extracted from the received certificate in the third step 306. As the term is used herein, “validation” denotes determining that the certificate was issued by an authentic continuing-education provider for attendance and completion of a continuing-education course by the participant-sender. In one embodiment, any text read or scanned from the certificate by the certificate-analysis module 116 is searched for one of a list of known continuing-education providers. This list of continuing-education providers may be maintained, along with other information regarding the providers, in the authority database 108. If a name of a continuing-education provider extracted from a received certificate matches the name of a provider in the authority database 108, the certificate-analysis module 116 may deem the certificate valid. The certificate-validation module 118 may search for and match additional extracted information about the provider, such as its address or telephone number, with information in the authority database 108.

The certificate-validation module 118 may employ other approaches to validation instead of or in addition to validation based on the name of the provider. In one embodiment, the certificate-analysis module 116 extracts from the certificate a sequence of alphanumeric (or other) characters that uniquely identifies the provider. The sequence of characters may be printed or encoded directly on or in the certificate or may be represented by a symbol, such as a one- or two-dimensional bar code. The certificate-validation module 118 compares this sequence of characters against information in the authority database 108 to thereby validate the certificate.

As mentioned above, other image information extracted from the certificate, such as a logo representing the provider, may similarly be extracted from the certificate by the certificate-analysis module 116 and compared to a library of logos and/or other image information in the authority database 108 by the certificate-validation module 118. The extracted images and the images in the authority database 108 may be compared using any method known in the art, such as a sum-of-absolute-differences algorithm. The certificate-validation module 118 may similarly match any relevant metadata and/or document properties extracted from the certificate against information in the authority database 108.

One or more of the above methods of validation may be combined to increase the accuracy of validation. In various embodiments, a plurality of validation processes are run on every certificate; the certificate is deemed valid only if each of the validation processes is successful (i.e., finds a successful match between extracted information and information in the authority database 108). For example, the certificate-validation module 118 may attempt to match the provider name and provider address with information in the authority database 108, returning a successful validation result only if both name and address are found. In another embodiment, one or more validation processes run only if one or more other validation processes are unsuccessful and/or are unable to run. For example, the certificate-validation module 118 may deem the received certificate valid if the extracted provider name is found in the authority database 108; if, however, the extracted provider name does not match (or only partially matches) a provider name in the authority database 108, and/or if the received certificate is corrupted or damaged such that the provider name cannot be extracted therefrom, the certificate-validation module 118 may instead validate the certificate by matching the provider address. The number and types of validity tests run may vary based on the type of input certificate received and/or the means of transmission thereof; a certificate received by fax, for example, may be deemed to have a greater presumption of validity than a certificate transmitted in plain text in the body of an email. The latter type of certificate and transmission, therefore, may be required to match a greater number of fields in the authority database 108.

An overall validation score may be determined from the one or more validation tests, and the certificate-validation module 118 may deem the certificate valid only if the score is greater than a predetermined threshold. A score for a given test may be based on a degree of match certainty and/or a predetermined weight assigned to a given test. For example, if an extracted provider name perfectly matches a name in the authority database 108 (i.e., the spelling, capitalization, font size, and/or font type match), a score of ten points out of a possible ten points may be assigned. If there are one or more mismatches, however, the score may be reduced to (e.g.) five or six points out of ten. A provider address may be deemed less reliable for validation; a perfect address match, therefore, may be scored out of only six points to reflect this lower reliability. In this example, the threshold for a score to validate the certificate, given these two tests, may be twelve points.

In one embodiment, the certificate-validation module 118 communicates with a third party, such as the CE provider (or an agent of the provider or a certifying authority), to validate the received certificate. For example, if the certificate includes a unique or semi-unique identification number or character string, the certificate-validation module 118 may send this string to a provider system (via, e.g., an API and the network interface 114). The provider system may respond to either validate or invalidate the received certificate; the certificate may be deemed invalid if, for example, no course corresponding to the certificate exists or if credit for the certificate has already been applied to the participant or to another participant. The contact information of the provider system (e.g., its Internet address) may be stored in the authority database 108.

In one embodiment, if validation fails and the certificate-validation module 118 deems the certificate invalid, the certificate-validation module 118 sends a message to the participant submitting the certificate (via email, fax, telephone, SMS message, or any other means) so informing the participant. The message may include an explanation of the reason for the failure and/or information for correcting or amending the certificate to overcome the failure. In one embodiment, a software application running on a client device of the participant displays the certificate and errors/problems therein and allows the participant to, though the software application, attempt to correct the errors.

In a fourth step 308, the certificate is parsed to determine the credit associated with the course for which the certificate was issued. As mentioned above, this parsing may take place before or after certificate validation. The certificate-analysis module 116 may also scan the certificate for the name of the participant, the name of the course(s) taken, the name of the participant's professional organization, the location of the course, and/or the region in which the credit was earned. If some or all of the information relating to the course cannot be parsed from the certificate, the certificate-analysis module 116 may attempt to locate the missing information in the authority database 108 and/or by communicating with a provider of the course (via the network interface 114) using information available in the certificate. For example, if the certificate-analysis module 116 determines the name and date of a course, but cannot determine the number of credit hours to be granted to the participant for the course, the certificate-analysis module 116 may access the authority database 108 and/or communicate with the provider to determine the credit hours given the name and date. Similarly, if some or all of the participant information cannot be parsed from the certificate, a user-management module 120 may attempt to locate the missing participant information in the user database 110. For example, if the name of the participant is found on the certificate but not the participant's associated professional organization, the user-management module 120 may query the user database 110 to supply this information, given the name.

A participant who submits a certificate may or may not have an existing user account in the user database 110. In one embodiment, a participant creates a user account by accessing the system 100 via, for example, a web-server interface (provided by, for example, the user-management module 120 or the web application server 204 of FIG. 2). The system 100 may request that the participant create a username and password and/or provide identification and security information. Once initialized, the user may specify his name, address, telephone number (and other contact information) as well as any associated professional organizations, one or more regions in which the participant practices his profession, and any credit requirements of the professional organizations for the region(s).

If a participant submits a certificate before setting up a user account, the user-management module 120 may save any information extracted from the certificate in a temporary account and prompt the submitting participant (via, for example, email or a web interface) to set up a user account. If the participant subsequently sets up a user account, the extracted information may be added to it. If the participant declines to set up a user account, the user-management module 120 may present or send to the user information related to the received certificate, such as to which professional organizations its credits may be applied and how much progress toward associated credit goals the credits in the certificate represent, even though the information in the certificate may not be saved for future sessions.

In one embodiment, a course-requirements database 112 maintains information related to one or more professional organizations and their associated requirements for continuing-education credits for particular countries, states, or regions. The course-requirements database 112 may specify, for example, that a given organization requires that its members accrue a first amount of continuing-education credits per year in a first state and a second amount of continuing-education credits per year in a second state. The course-requirements database 112 may further specify which courses, or types of courses, may be used to satisfy the continuing-education credit requirement for a particular organization in a particular country, state, or region.

Information in the course-requirements database 112 may be entered manually by a human via the network interface 114. In other embodiments, a professional organization transmits a document specifying its credit requirements physically or electronically to the system 100, and this information may be read automatically into the course-requirements database 112. The user-management module 120 may query a system belonging to an organization (via, for example, an API), download the credit information, and add it to the course-requirements database 112. In various embodiments, the information in the course-requirements database 112 may be updated periodically (e.g., once per year or once per quarter year) either manually or automatically (by, for example, the user-management module 120 periodically issuing a web-based or API call to an organization system).

A participant may log into or otherwise access the system 100, via the web or a software application, and view his or her accumulated credits and progress toward credit goals. If the participant is a member of multiple organizations and/or practices in multiple regions within a single organization, she may view each organization/region and progress toward credit goals in each. The participant may also review any certificates submitted to verify that her credits have been properly applied. If she believes that her credits have been applied in error or have not been applied in error, she may flag the corresponding certificate for follow-up. Such follow-up may include the system 100 sending a message prompting the participant to describe the alleged error in greater detail, specify how the participant believes the credits should have been applied, or initiate an out-of-band communication (e.g., a phone call) with a maintainer of the system 100. The user-management module 120 may instead or in addition communicate with the relevant organization, provider, or both (via the network interface 114 or other means) to attempt to resolve the issue.

In one embodiment, the user-management module 120 may further present a participant (or other user of the system 100) with upcoming courses relevant to the participant's organization, region, and remaining credit requirements. For example, if a participant needs a certain number of credits in a certain type of courses by a certain deadline, the user-management module 120 may present the participant (via email or web) with a list of upcoming courses that, if taken and completed, would fulfill the requirements. The list of courses may be stored in the course-requirements database 112 and/or loaded dynamically by, for example, accessing a web- or network-based list of courses provided by an organization or provider(s). In some embodiments, the user-management module 120 permits the participant to sign up for the course(s) and communicates the sign-up information to the relevant course providers. The user-management module 120 may send reminders to the participant (via, for example, email, SMS messaging, or in-application alerts) of upcoming courses. In another embodiment, the user-management module 120 sends additional reminders to a participant of upcoming credit-requirement deadlines and may include a list of courses that may be taken to meet the requirements.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for electronically validating continuing-education certificates, the method comprising:
receiving, from a participant in a continuing-education course, electronic information comprising a certificate indicating completion of the continuing-education course;
computationally analyzing the certificate to determine an identity of a provider of the continuing-education course;
validating the certificate by electronically comparing the identity of the provider to an authority file;
electronically determining a course credit associated with the continuing-education course; and
updating a user database comprising a user account associated with the participant to reflect the course credit.

2. The method of claim 1, wherein analyzing the certificate comprises extracting text from the received information.

3. The method of claim 2, wherein extracting text comprises performing optical-character recognition on image data in the certificate.

4. The method of claim 1, wherein analyzing the certificate further comprises determining an address, logo, or letterhead of the provider and wherein validating the certificate further comprises comparing the address, logo, or letterhead to an authority file.

5. The method of claim 1, wherein analyzing the certificate further comprises determining a unique identifier associated with the certificate and wherein validating the certificate further comprises comparing the unique identifier to an authority file.

6. The method of claim 5, wherein the unique identifier is a serial number, an alphanumeric string, a one-dimensional bar code, or a two-dimensional bar code.

7. The method of claim 5, wherein validating the certificate further comprises querying a third party with the unique identifier.

8. The method of claim 1, further comprising applying the course credit to a course-credit requirement associated with a professional organization in which the participant is a member.

9. The method of claim 8, further comprising determining the course-credit requirement based on requirements associated with the professional organization.

10. A system for validating continuing-education certificates, the system comprising:
an authority database for storing an authority file comprising validation information associated with a provider of a continuing-education course; and
a processor for executing computer instructions for:
i. receiving, from a participant in the continuing-education course, electronic information comprising a certificate indicating completion of the continuing-education course;
ii. computationally analyzing the certificate to determine an identity of the provider of the continuing-education course;
iii. validating the certificate by comparing the identity of the provider to the authority file;
iv. determining a course credit associated with the continuing-education course; and
v. updating a user database comprising a user account associated with the participant to reflect the course credit.

11. The system of claim 10, wherein the electronic information is received from a web browser, mobile device, or email account.

12. The system of claim 10, wherein the electronic information comprises an email, image file, fax, or MMS message.

13. The system of claim 10, further comprising a course-requirements database for storing course-credit requirement information associated with a professional organization in which the participant is a member.

14. The system of claim 14, further comprising determining the course-credit requirement based on requirements associated with the professional organization.

15. The system of claim 10, wherein analyzing the certificate comprises extracting text from the received information.

16. The system of claim 15, wherein extracting text comprises performing optical-character recognition on image data in the certificate.

17. The system of claim 15, wherein analyzing the certificate further comprises determining an address, logo, or letterhead of the provider and wherein validating the certificate further comprises comparing the address, logo, or letterhead to an authority file.
